(19) United States
(12) Patent Application Publication
(10) Pub. No.: US 2012/0212417 A1
(43) Pub. Date: Aug. 23, 2012

(54) KEYBOARD

(75) Inventor: Bo-An Chen, Taipei (TW)

(73) Assignee: PRIMAX ELECTRONICS LTD., Taipei (TW)

(21) Appl. No.: 13/079,669

(22) Filed: Apr. 4, 2011

(30) Foreign Application Priority Data
Feb. 18, 2011 (TW) 100105380

(51) Int. Cl. G06F 3/02

(52) U.S. Cl. 345/168

(57) ABSTRACT

The present invention discloses a keyboard including a plurality of keys and a membrane circuit board. Each key is used to trigger a corresponding membrane switch of the membrane circuit board. The membrane circuit board includes an antenna circuit. The antenna circuit is arranged inside the membrane circuit board, and not exposed to the upper surface or the lower surface of the membrane circuit board. The present invention increases an arranged area of the antenna circuit for improving the allowed length of the antenna circuit, so as to enhancing the transmission reception quality of wireless signals.

### FIELD OF THE INVENTION

The present invention generally relates to a keyboard, and more particularly to a keyboard with a function of transmitting or receiving a wireless signal.

### BACKGROUND OF THE INVENTION

As advancement of the technology development, the computer system and the peripherals thereof develop rapidly. In the modern computer system, the input device of the host plays an important role, wherein the input device comprises a keyboard, a mouse, a trackball, a presenter and so on. However, the keyboard is the most popular one of the input devices since users may process various paper works by pressing keys of a keyboard to input various words, numbers, or symbols.

In general, the keyboard is connected with the host by wire, such as using a cable with a universal serial bus (USB) or a personal system/2 (PS/2) interface. However, the kind of connection manner may not only limit an operation distance of the keyboard from the computer due to the length of the cable of the keyboard, but also interfere the user with the cable during the user operating the keyboard. Thus, wireless keyboards substitute the wired keyboards and become more popular one due to resolving the issues.

FIG. 1 illustrates a structural sectional view of a conventional wireless keyboard, and FIG. 2 illustrates a partial structural view of the keyboard as illustrated in FIG. 1. Referring to FIG. 1 and FIG. 2, the wireless keyboard 1 comprises a plurality of keys 10, a membrane circuit board 13, a circuit board 11 electrically connected with the membrane circuit board 13, and a base 12 for carrying the above mentioned components, wherein the membrane circuit board 13 has a plurality of membrane switches 131, and each of the keys 10 is disposed over each of the membrane switches 131 correspondingly. When any one of the keys 10 is pressed to move downwards, the key 10 pushes the corresponding one of the membrane switches 131 and thus switches on the corresponding one of the membrane switches 131, so as to generate and transmit a corresponding key signal to the circuit board 11. After that, an electronic component 111 on the circuit board 11 implements a signal processing to transform the key signal into a digital signal able to be read by the host (not shown). Moreover, the circuit board 11 has an antenna circuit 112, and the wireless keyboard 1 transmits the wireless signal to the host by the antenna circuit 112. Therefore, the key signal implemented with signal processing may be transmitted to the host by the antenna circuit 112.

In view of the modern electronic products tend to light, thin, short, and small more and more over, each of the components in the wireless keyboard 1 are also miniaturized to let the assembled wireless keyboard 1 is small and easy to be carried. Therefore, the circuit board 11 of the wireless keyboard 1 must have a small surface due to the forgoing limitation, and thus the arrangement area of the antenna circuit 112 on the circuit board 11 is reduced, and accordingly the transmission reception quality of the wireless signal of the wireless keyboard 1 is decreased. In another word, the length of the antenna circuit 112 is proportional to the transmission reception quality of the wireless signal of the wireless keyboard 1. However, enlarging the size of the circuit board 11 for increasing the length of the disposed antenna circuit 112 may not only deviate from the design rule of light, thin, short, and small, but also increase the manufacturing cost of the circuit board 11. Besides, an electromagnetic disturbance (EMI) effect is likely to be caused between the antenna circuit 112 disposed on the circuit board 11 and other electronic components 111 disposed on the circuit board 11. Accordingly, the conventional wireless keyboard 1 needs to be improved.

### SUMMARY OF THE INVENTION

The present invention is directed to a keyboard, wherein the arranged area of the antenna circuit is enlarged, so as to increase the length of the antenna circuit able to be arranged.

In a preferred embodiment, the present invention provides a keyboard comprising:
a membrane circuit board, comprising:
   a lower board, having a first circuit layout on an upper surface thereof, and the first circuit layout having a plurality of lower contacts;
   an upper board, having a second circuit layout on an lower surface thereof, and the second circuit layout having a plurality of upper contacts corresponding to the plurality of lower contacts, wherein each of the plurality of upper contacts is distant from the corresponding one of the plurality of lower contacts with a distance and forms a membrane switch with the corresponding one of the plurality of lower contacts in common; and
   an antenna membrane, having an antenna circuit, and the antenna circuit located between the antenna membrane and the lower board or between the antenna membrane and the upper board, wherein the keyboard transmits or receives a wireless signal by using the antenna circuit; and
a plurality of keys, for corresponding to and switching on the plurality of membrane switches.

In a preferred embodiment, the antenna membrane is disposed under the lower board and the antenna circuit is formed on an upper surface of the antenna membrane, and thus the antenna circuit is located between the antenna membrane and the lower board.

In a preferred embodiment, the antenna membrane is disposed over the upper board and the antenna circuit is formed on a lower surface of the antenna membrane, and thus the antenna circuit is located between the antenna membrane and the upper board.

In a preferred embodiment, the antenna membrane is disposed between the upper board and the lower board, and the antenna circuit is located between the antenna membrane and the lower board when the antenna circuit is formed on a lower surface of the antenna membrane, or the antenna circuit is located between the antenna membrane and the upper board when the antenna circuit is formed on an upper surface of the antenna membrane.

In a preferred embodiment, the membrane circuit board further comprises a middle board disposed between the lower board and the upper board, so as to form the distance between each of the upper contacts and the corresponding one of the lower contacts, and the middle board has a plurality of openings corresponding to the plurality of lower contacts and the plurality of upper contacts.

In a preferred embodiment, the antenna membrane is disposed between the upper board and the middle board, and the antenna circuit is located between the antenna membrane and the middle board when the antenna circuit is formed on a lower surface of the antenna membrane, or the antenna circuit is located between the antenna membrane and the upper board when the antenna circuit is formed on an upper surface of the antenna membrane.

In a preferred embodiment, the antenna membrane is disposed between the lower board and the middle board, and the antenna circuit is located between the antenna membrane and the lower board when the antenna circuit is formed on a lower surface of the antenna membrane, or the antenna circuit is located between the antenna membrane and the middle board when the antenna circuit is formed on an upper surface of the antenna membrane.

In a preferred embodiment, each of the keys has a cap and an elastomer, and the elastomer is disposed between the cap and the membrane circuit board. The elastomer is compressed to push the corresponding one of the membrane switches when the cap is pressed. Alternatively, the elastomer provides an elastic force to the cap for returning the position of the cap when the cap is released.

In a preferred embodiment, the present invention further provides a keyboard comprising:
a membrane circuit board, comprising:
   a switch membrane, having a switch circuit layout on an upper surface thereof, and the switch circuit layout having a plurality of membrane switches; and
   an antenna membrane, having an antenna circuit on an upper surface thereof, and the antenna membrane is disposed under the switch membrane, wherein the keyboard transmits or receives a wireless signal by using the antenna membrane; and
a plurality of keys, for corresponding to and switching on the plurality of membrane switches.

In a preferred embodiment, each of the membrane switches comprises a first conductive portion and a second conductive portion, and the first conductive portion is separated from the second conductive portion.

In a preferred embodiment, each of the keys has a cap and a conductor, the conductor is disposed between the cap and the membrane circuit board, and the conductor contacts and thus switches on the corresponding one of the membrane switches when the cap is pressed.

In a preferred embodiment, the present invention also provides a keyboard comprising:
a membrane circuit board, comprising:
   a lower board, having a first circuit layout on an upper surface thereof, and the first circuit layout having a plurality of lower contacts;
   an upper board, having a second circuit layout on an lower surface thereof, and the second circuit layout having a plurality of upper contacts corresponding to the plurality of lower contacts, wherein each of the plurality of upper contacts is distant from the corresponding one of the plurality of lower contacts with a distance and forms a membrane switch with the corresponding one of the plurality of lower contacts in common; and
   an antenna circuit, located between the lower board and the upper board, wherein the keyboard transmits or receives a wireless signal by using the antenna circuit; and
a plurality of keys, for corresponding to and switching on the plurality of membrane switches.

In a preferred embodiment, the membrane circuit board further comprises a middle board disposed between the lower board and the upper board, so as to form the distance between each of the upper contacts and the corresponding one of the lower contacts, and the middle board has a plurality of openings corresponding to the plurality of lower contacts and the plurality of upper contacts.

In a preferred embodiment, the antenna circuit is formed on an upper surface or a lower surface of the middle board.

In a preferred embodiment, each of the keys has a cap and an elastomer, and the elastomer is disposed between the cap and the membrane circuit board. The elastomer is compressed to push the corresponding one of the membrane switches when the cap is pressed. Alternatively, the elastomer provides an elastic force to the cap for returning the position of the cap when the cap is released.

### BRIEF DESCRIPTION OF THE DRAWINGS

FIG. 1 illustrates a structural sectional view of a conventional wireless keyboard.

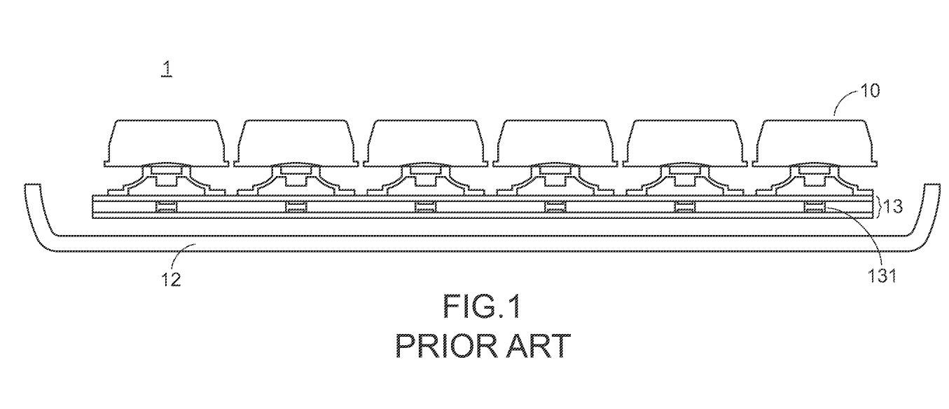

FIG. 2 illustrates a partial structural view of the keyboard as illustrated in FIG. 1.

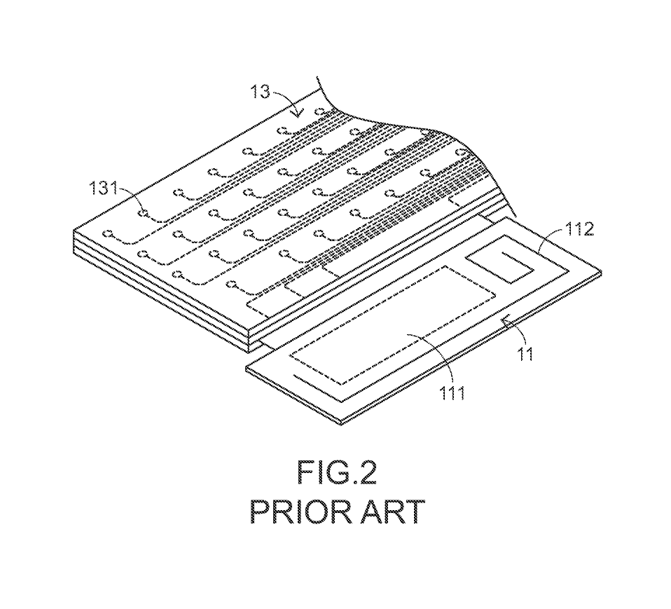

FIG. 3 illustrates a structural sectional view of a keyboard according to a first preferred embodiment of the present invention.

FIG. 4 illustrates a structural view of the membrane circuit board and the circuit board of the keyboard as illustrated in FIG. 3.

FIG. 5 illustrates a perspective explosion view of the membrane circuit board of the keyboard as illustrated in FIG. 3.

FIG. 6 illustrates a perspective explosion view of the membrane circuit board of the keyboard according to a second preferred embodiment of the present invention.

FIG. 7 illustrates a perspective explosion view of the membrane circuit board of the keyboard according to a third preferred embodiment of the present invention.

FIG. 8 illustrates a perspective explosion view of the membrane circuit board of the keyboard according to a fourth preferred embodiment of the present invention.

FIG. 9 illustrates a perspective explosion view of the membrane circuit board of the keyboard according to a fifth preferred embodiment of the present invention.

FIG. 10 illustrates a perspective explosion view of the membrane circuit board of the keyboard according to a sixth preferred embodiment of the present invention.

FIG. 11 illustrates a structural sectional view of the keyboard according to a seventh preferred embodiment of the present invention.

FIG. 12 illustrates a perspective explosion view of the membrane circuit board of the keyboard as illustrated in FIG. 11.

FIG. 13 illustrates a structural sectional view of the keyboard according to an eighth preferred embodiment of the present invention.

FIG. 14 illustrates a perspective explosion view of the membrane circuit board of the keyboard as illustrated in FIG. 13.

FIG. 15 illustrates a perspective explosion view of the membrane circuit board of the keyboard according to a ninth preferred embodiment of the present invention.

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

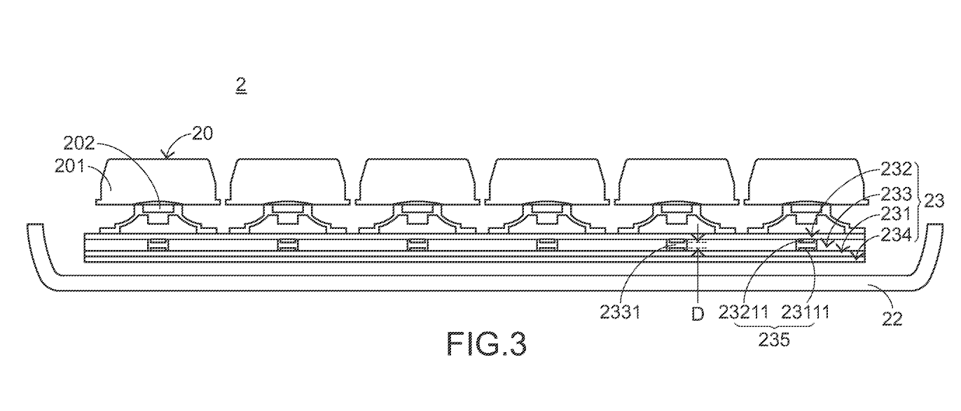

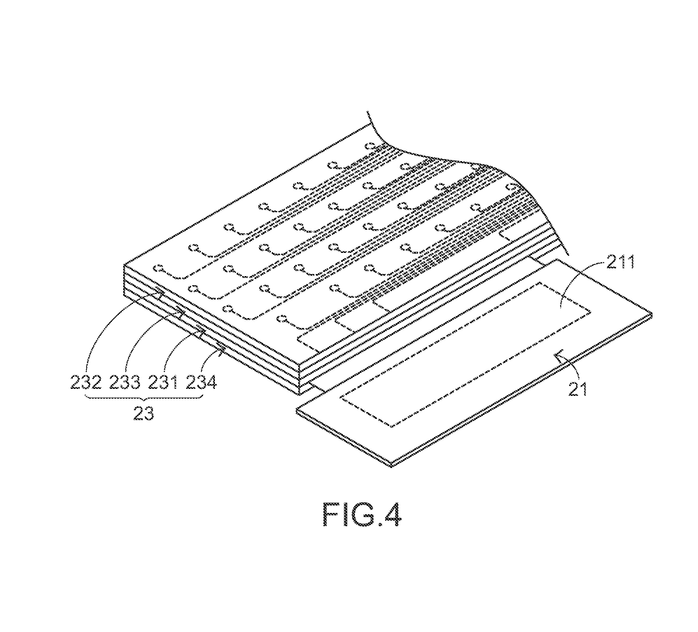

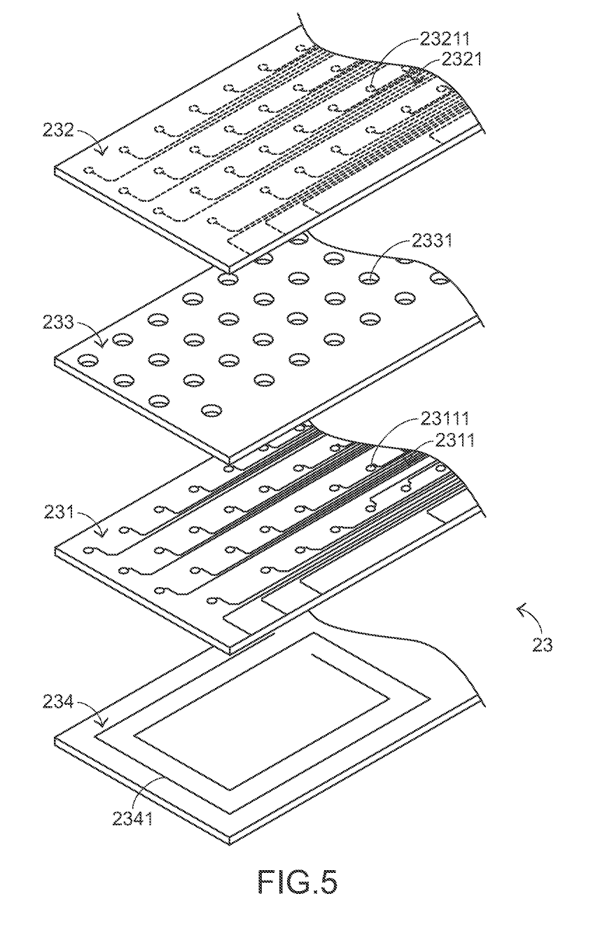

FIG. 3 illustrates a structural sectional view of a keyboard according to a first preferred embodiment of the present invention, FIG. 4 illustrates a structural view of the membrane circuit board and the circuit board of the keyboard as illustrated in FIG. 3, and FIG. 5 illustrates a perspective explosion view of the membrane circuit board of the keyboard as illustrated in FIG. 3. Referring to FIG. 3 to FIG. 5, the keyboard 2 comprises a plurality of keys 20, a membrane circuit board 23, a circuit board 21 electrically connected with the membrane circuit board 23, and a base 22 for carrying the above mentioned components.

In the present embodiment, the membrane circuit board 23 comprises a lower board 231 and a upper board 232. The lower board 231 has a first circuit layout 2311 on an upper surface thereof, and the first circuit layout 2311 has a plurality of lower contacts 23111, while the upper board 232 has a second circuit layout 2321 on a lower surface thereof, and the second circuit layout 2321 has a plurality of upper contacts 23211 corresponding to the plurality of lower contacts 23111. Herein, each of the upper contacts 23211 is distant from the corresponding one of the lower contacts 23111 with a distance D and forms a membrane switch 235 with the corresponding one of the lower contacts 23111 in common. In the present embodiment, the membrane circuit board 23 further comprises a middle board 233 disposed between the lower board 231 and the upper board 232, so as to form the distance D between each of the upper contacts 23211 and the corresponding one of the lower contacts 23111, wherein the middle board 233 has a plurality of openings 2331 corresponding to the plurality of lower contacts 23111 and the plurality of upper contacts 23211.

In addition, the plurality of keys 20 are disposed to where corresponding to the plurality of membrane switches 235, and each key 20 of the plurality of keys 20 has a cap 201 and an elastomer 202. The elastomer 202 is disposed between the cap 201 and the membrane circuit board 23. When any one of the keys 20 is pressed to move downwards, the cap 201 of the key 20 compresses the elastomer 202 of the key 20 to let the elastomer 202 push the corresponding one of the upper contacts 23211, and then let the corresponding one of the upper contacts 23211 contact the corresponding one of the lower contacts 23111 via the corresponding one of the openings 2331. Hence, the corresponding one of the membrane switches 235 is switched on, so as to generate and transmit a corresponding key signal to the circuit board 21. An electronic circuit 211 of the circuit board 21 further implements a signal processing to transform the key signal into a digital signal able to be read by a host (not shown). However, when the cap 201 is released, the position of the cap 201 returns upwards due to an elastic force of the elastomer 202.

The features of the present invention are illustrated herein after. The membrane circuit board 23 further comprises an antenna membrane 234 with an antenna circuit 2341. A preferred approach of forming the antenna circuit 2341 on a surface of the antenna membrane 234 may be, but not limited to, an adhering process, a sputtering deposition process or a pressing process. Herein, the keyboard 2 may transmit wireless signals with the host (not shown) end via the antenna circuit 2341. In another word, when any one of the membrane switches 235 is switched on to form a corresponding key signal, and the key signal is transformed into a digital signal able to be read by the host, the key signal is able to be transmitted to the host via the antenna circuit 2341. In the present embodiment, the antenna membrane 234 is disposed under the lower board 231 and the antenna circuit 2341 is formed on an upper surface of the antenna membrane 234, and thus the antenna circuit 2341 is located between the antenna membrane 234 and the lower board 231.

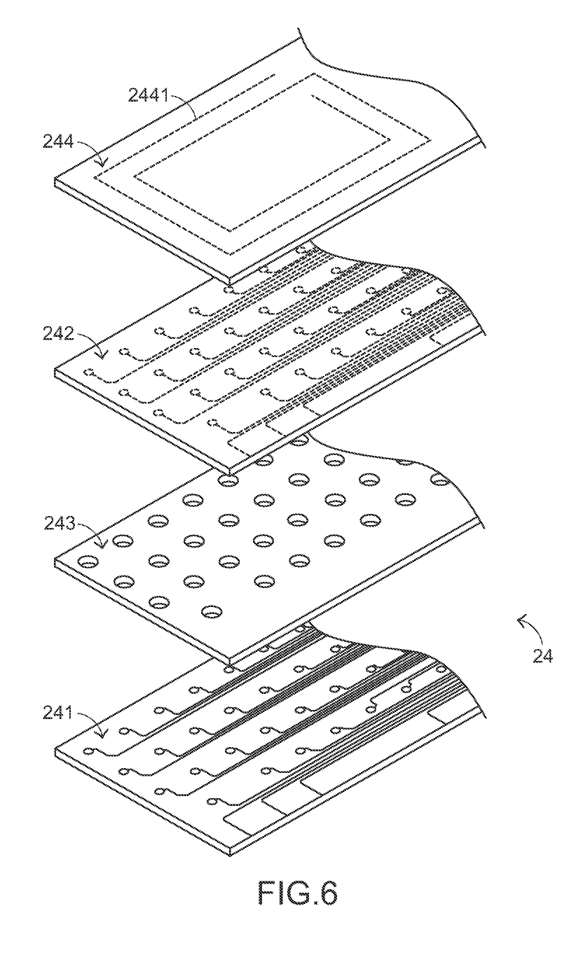

FIG. 6 illustrates a perspective explosion view of the membrane circuit board of the keyboard according to a second preferred embodiment of the present invention. Referring to FIG. 6 hereinafter, the parts of the keyboard in the present embodiment that is substantially similar to the keyboard as illustrated in the first preferred embodiment of the present invention are omitted herein, for example, the middle board 243 of the membrane circuit board 24 is still located between the lower board 241 and the upper board 242. What the present embodiment different to the above mentioned first preferred embodiment is that the antenna membrane 244 of the membrane circuit board 24 is disposed above the upper board 242, and the antenna circuit 2441 is formed on a lower surface of the antenna membrane 244, and thus the antenna circuit 2441 is located between the antenna membrane 244 and the upper board 242.

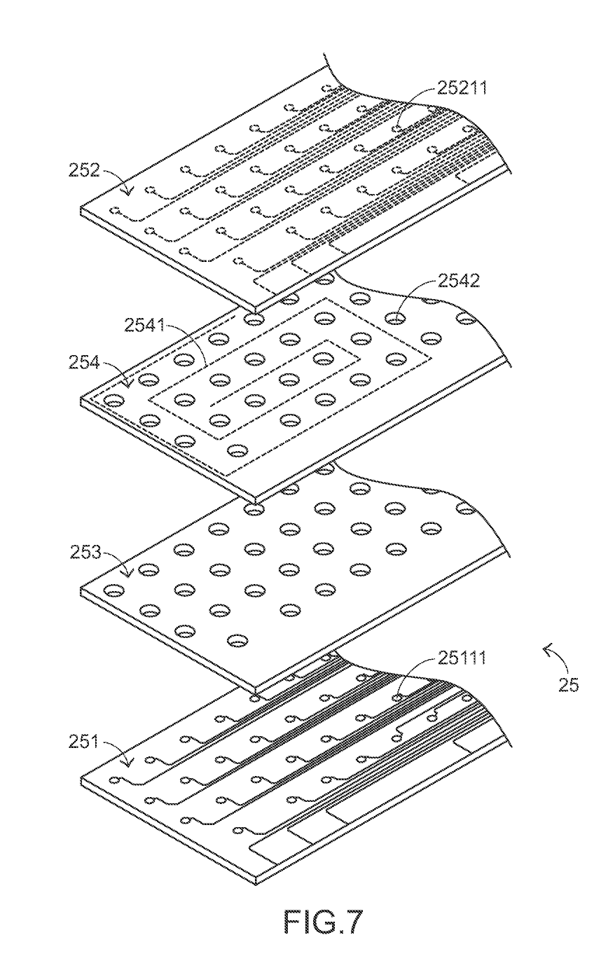

FIG. 7 illustrates a perspective explosion view of the membrane circuit board of the keyboard according to a third preferred embodiment of the present invention. Referring to FIG. 7 hereinafter, the parts of the keyboard in the present embodiment that is substantially similar to the keyboard as illustrated in the first preferred embodiment of the present invention are omitted herein. What the present embodiment different to the above mentioned first preferred embodiment is that the antenna membrane 254 of the membrane circuit board 25 is disposed between the upper board 252 and the middle board 253, and the antenna membrane 254 has a plurality of openings 2542 corresponding to the plurality of lower contacts 25111 and the plurality of upper contacts 25211. Hence, each of the upper contacts 25211 may successfully contact the corresponding one of the lower contacts 25111 when being pushed by the elastomer (not shown). In the present embodiment, the antenna circuit 2541 is formed on the lower surface of the antenna membrane 254 and mismatched with the plurality of openings 2542 of the antenna membrane 254, and thus the antenna circuit 2541 is located between the antenna membrane 254 and the lower board 251.

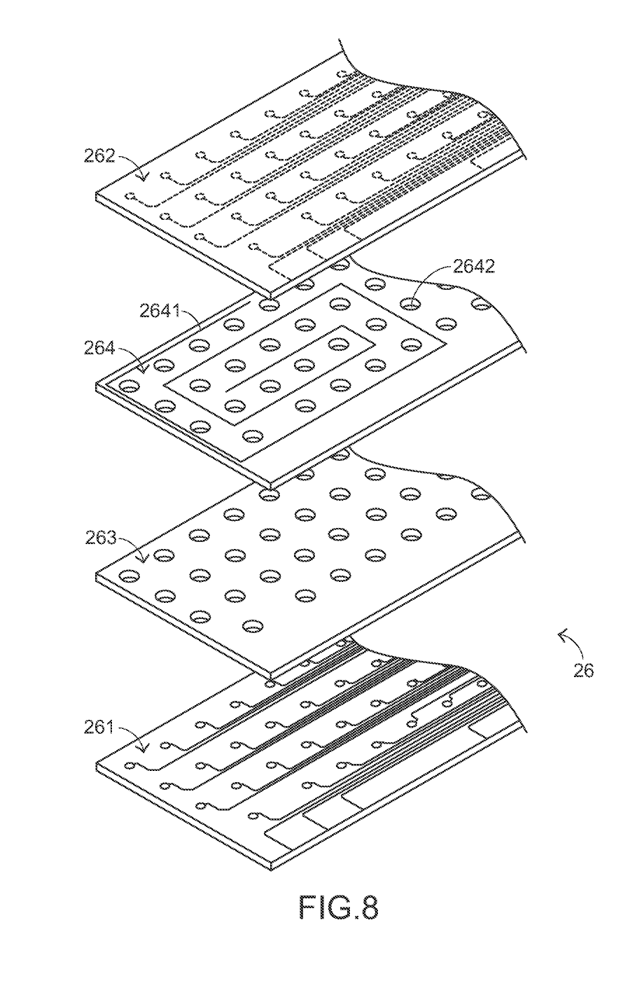

FIG. 8 illustrates a perspective explosion view of the membrane circuit board of the keyboard according to a fourth preferred embodiment of the present invention. Referring to FIG. 8 hereinafter, the parts of the keyboard in the present embodiment that is substantially similar to the keyboard as illustrated in the third preferred embodiment of the present invention are omitted herein, for example, the antenna membrane 264 of the membrane circuit board 26 is still located between the upper board 262 and the middle board 263, and the middle board 263 is still located between the antenna membrane 264 and the lower board 261. What the present embodiment different to the above mentioned third preferred embodiment is that the antenna circuit 2641 of the membrane circuit board 26 is formed on the upper surface of the antenna membrane 264 and mismatched with the plurality of openings 2642 of the antenna membrane 264, and thus the antenna circuit 2641 is located between the antenna membrane 264 and the upper board 262.

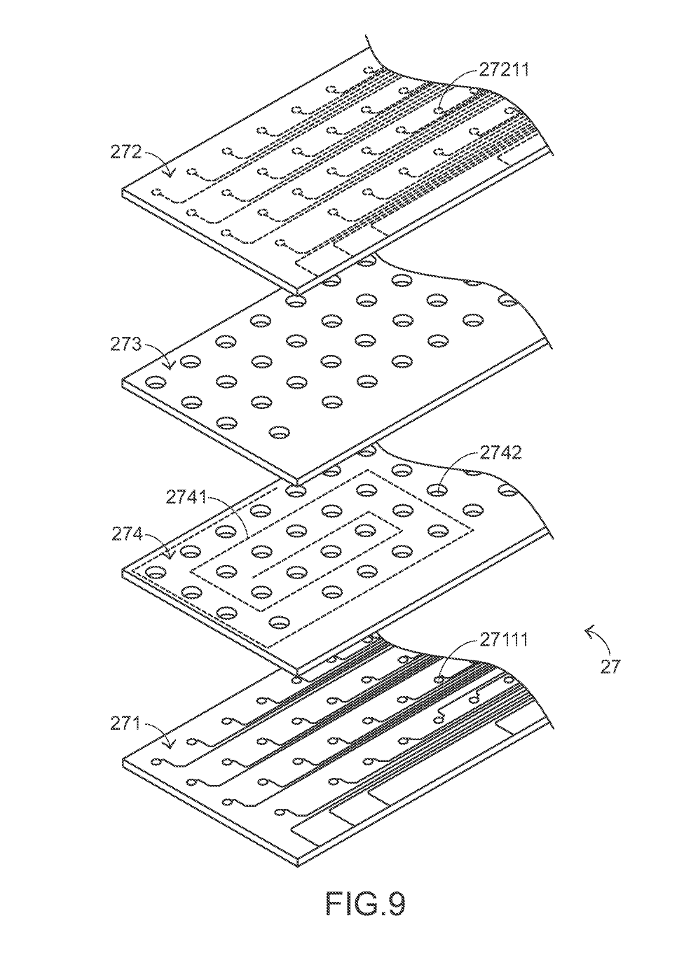

FIG. 9 illustrates a perspective explosion view of the membrane circuit board of the keyboard according to a fifth preferred embodiment of the present invention. Referring to FIG. 9 hereinafter, the parts of the keyboard in the present embodiment that is substantially similar to the keyboard as illustrated in the first preferred embodiment of the present invention are omitted herein. What the present embodiment different to the above mentioned first preferred embodiment is that the middle board 273 of the membrane circuit board 27 is located between the upper board 272 and the antenna membrane 274, and the antenna membrane 274 is disposed between the lower board 271 and the middle board 273 and has a plurality of openings 2742 corresponding to the plurality of lower contacts 27111 and the plurality of upper contacts 27211. Hence, each of the upper contacts 27211 may successfully contact the corresponding one of the lower contacts 27111 when being pushed by the elastomer (not shown). In the present embodiment, the antenna circuit 2741 is formed on the lower surface of the antenna membrane 274 and mismatched with the plurality of openings 2742 of the antenna membrane 274, and thus the antenna circuit 2741 is located between the antenna membrane 274 and the lower board 271.

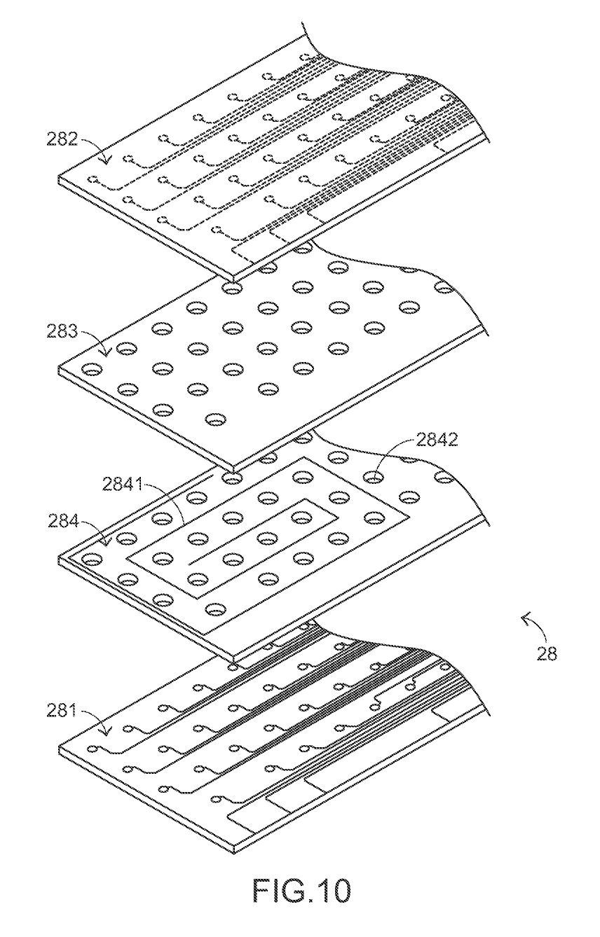

FIG. 10 illustrates a perspective explosion view of the membrane circuit board of the keyboard according to a sixth preferred embodiment of the present invention. Referring to FIG. 10 hereinafter, the parts of the keyboard in the present embodiment that is substantially similar to the keyboard as illustrated in the fifth preferred embodiment of the present invention are omitted herein, for example, the antenna membrane 284 of the membrane circuit board 28 is still located between the lower board 281 and the middle board 283, and the middle board 283 is still located between the antenna membrane 284 and the upper board 282. What the present embodiment different to the above mentioned fifth preferred embodiment is that the antenna circuit 2841 is formed on the upper surface of the antenna membrane 284 and mismatched with the plurality of openings 2842 of the antenna membrane 284, and thus the antenna circuit 2841 is located between the antenna membrane 284 and the upper board 282.

It should be note that the antenna circuit of the antenna membrane in each of the first to sixth preferred embodiments is located between the antenna membrane and the lower board or between the antenna membrane and the upper board, but not exposed on the upper surface or the lower surface of the membrane circuit board, because a keyboard manufactured from the production line needs to be processed by an electrostatic discharge (ESD) test (which is well known by person having original skill in the art and omitted herein). In general, a circuit generated during the ESD test is conducted to a Ground line, and thus not to affect the operation of the keyboard. However, if the antenna circuit is formed on the upper surface or the lower surface of the membrane circuit board, the circuit generated during the ESD test is conducted to the circuit board via the antenna circuit, and thus electronic components mounted on the circuit board may be damaged.

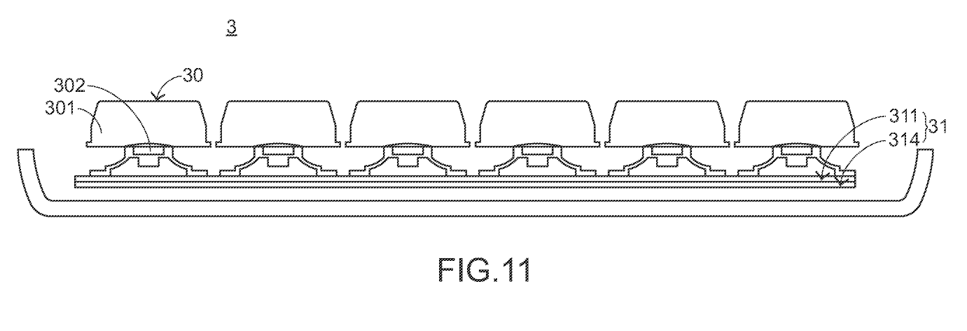

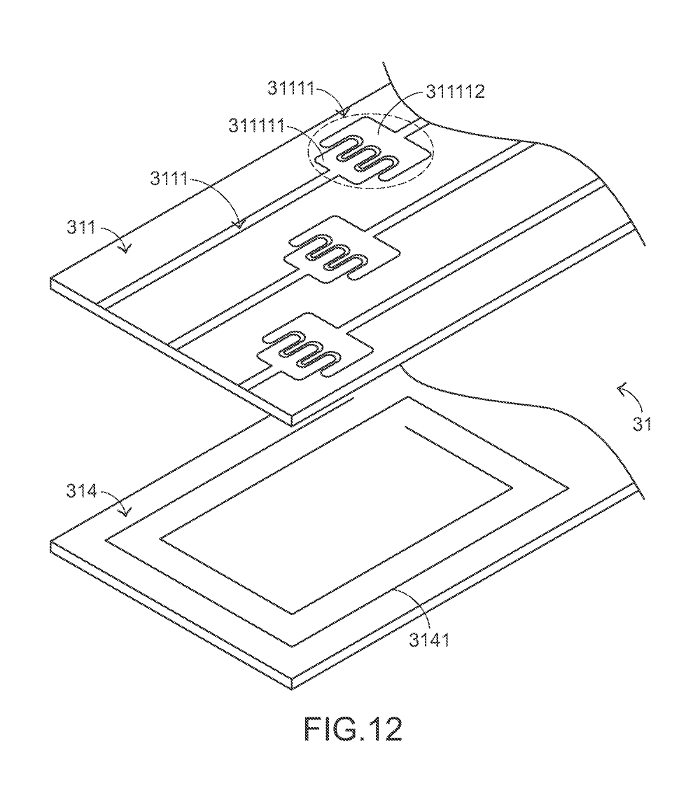

A seventh preferred embodiment of the present invention is illustrated hereinafter. FIG. 11 illustrates a structural sectional view of the keyboard according to a seventh preferred embodiment of the present invention, and FIG. 12 illustrates a perspective explosion view of the membrane circuit board of the keyboard as illustrated in FIG. 11. Herein, the parts of the keyboard 3 in the present embodiment that is substantially similar to the keyboard as illustrated in the first preferred embodiment of the present invention are omitted herein.

What the present embodiment different to the above mentioned first preferred embodiment is that the membrane circuit board 31 comprises a switch membrane 311 and an antenna membrane 314. An upper surface of the switch membrane 311 has a circuit layout 3111, and the circuit layout 311 has a plurality of membrane switches 31111. Each of the membrane switches 31111 comprises a first conductive portion 311111 and a second conductive portion 311112, and the first conductive portion 311111 is separated from the second conductive portion 311112. In addition, the antenna membrane 314 is disposed under the switch membrane 311, and the antenna circuit 3141 is formed on the upper surface of the antenna membrane 314. Further, each of the keys 30 has a cap 301 and a conductor 302, and the conductor 302 is disposed between the cap 301 and the membrane circuit board 31. When any one of the caps 31 is pressed, the corresponding one of the conductors 302 contacts and thus switches on the corresponding one of the membrane switches 31111 to generate a corresponding key signal. Similarly, the key signal may be transformed into a digital signal able to be read by the host via a circuit board (not shown), and then transmitted to the host via the antenna circuit 3141.

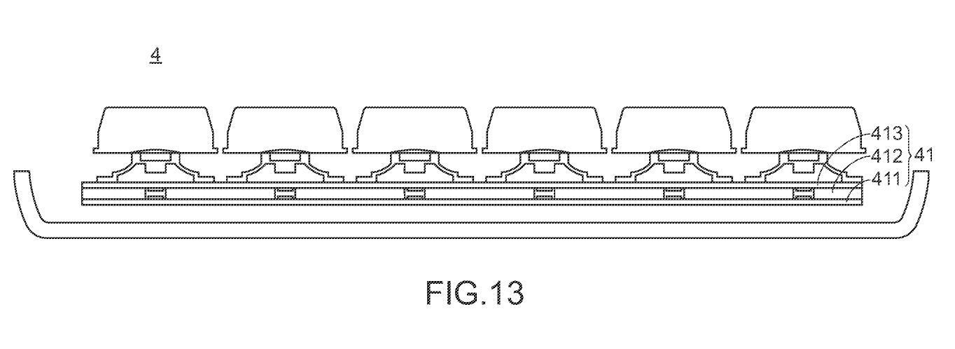

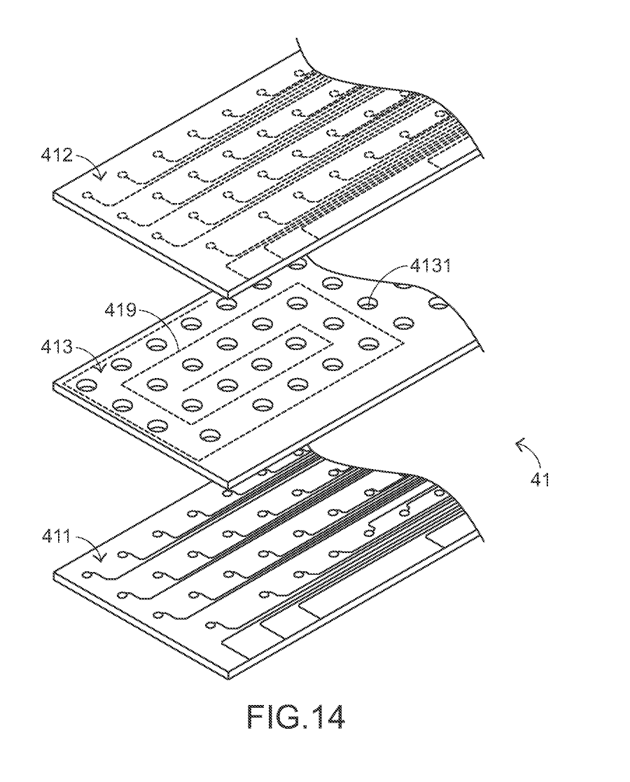

An eighth preferred embodiment of the present invention is illustrated hereinafter. FIG. 13 illustrates a structural sectional view of the keyboard according to an eighth preferred embodiment of the present invention, and FIG. 14 illustrates a perspective explosion view of the membrane circuit board of the keyboard as illustrated in FIG. 13. Herein, the parts of the keyboard 4 in the present embodiment that is substantially similar to the keyboard as illustrated in the first preferred embodiment of the present invention are omitted herein.

What the present embodiment different to the above mentioned first preferred embodiment is that the membrane circuit board 41 doesn't comprise an antenna membrane 414, and an antenna circuit 419 is directly formed on the lower surface of the middle board 413 and mismatched with the plurality of openings 4131 of the middle board 413, and thus the antenna circuit 414 is located between the upper board 412 and the lower board 411 and not exposed on the upper surface or the lower surface of the membrane circuit board 41.

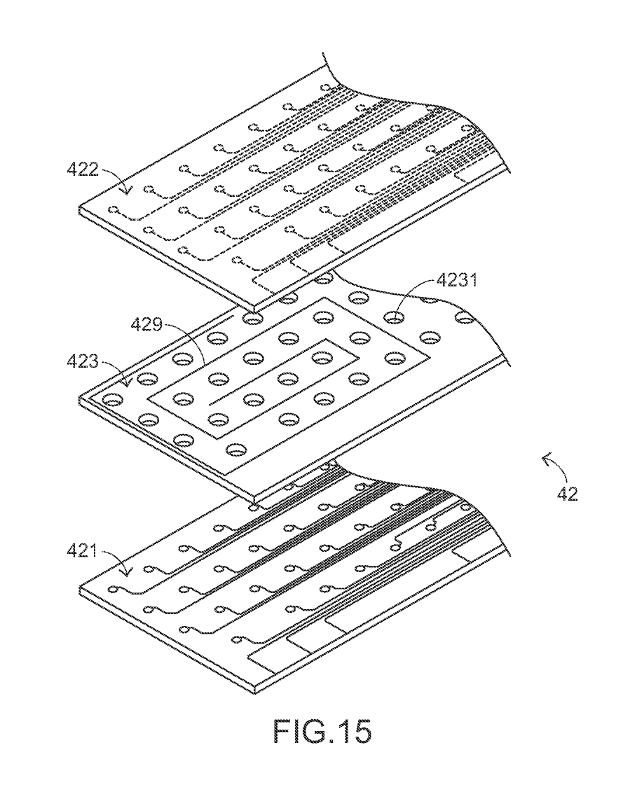

FIG. 15 illustrates a perspective explosion view of the membrane circuit board of the keyboard according to a ninth preferred embodiment of the present invention. Referring to FIG. 15 hereinafter, the parts of the keyboard in the present embodiment that is substantially similar to the keyboard as illustrated in the eighth preferred embodiment of the present invention are omitted herein, for example, the antenna circuit 424 is located between the upper board 422 and the lower board 421. What the present embodiment different to the above mentioned eighth preferred embodiment is that the antenna circuit 429 is directly formed on the upper surface of the middle board 423 and mismatched with the plurality of openings 4231 of the middle board 423, and thus the antenna circuit 429 is not exposed on the upper surface or the lower surface of the membrane circuit board 42 as well.

According to each of the above mentioned preferred embodiments, it is understood that the feature of the present invention is placing an antenna membrane in the membrane circuit board of the keyboard for disposing an antenna circuit. Therefore, comparing to the antenna circuit may only be disposed on a specific region of the circuit board in the conventional art, an advantage of the present invention is that the region for disposing the antenna circuit is larger. Accordingly, qualities of transmitting and receiving wireless signals by using the keyboard of the present invention are better, due to lengthening the length of the antenna circuit is possible. In addition, the antenna circuit is not disposed on the circuit board, and thus unable to generate EMI with other electronic components disposed on the circuit board.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A keyboard, comprising:
a membrane circuit board, comprising:
a lower board, having a first circuit layout on an upper surface thereof, and the first circuit layout having a plurality of lower contacts;
an upper board, having a second circuit layout on an lower surface thereof, and the second circuit layout having a plurality of upper contacts corresponding to the plurality of lower contacts, wherein each of the plurality of upper contacts is distant from the corresponding one of the plurality of lower contacts with a distance and forms a membrane switch with the corresponding one of the plurality of lower contacts in common; and
an antenna membrane, having an antenna circuit, and the antenna circuit located between the antenna membrane and the lower board or between the antenna membrane and the upper board, wherein the keyboard transmits or receives a wireless signal by using the antenna circuit; and
a plurality of keys, for corresponding to and switching on the plurality of membrane switches.

2. The keyboard as claimed in claim 1, wherein the antenna membrane is disposed under the lower board and the antenna circuit is formed on an upper surface of the antenna membrane, and thus the antenna circuit is located between the antenna membrane and the lower board.

3. The keyboard as claimed in claim 1, wherein the antenna membrane is disposed over the upper board and the antenna circuit is formed on a lower surface of the antenna membrane, and thus the antenna circuit is located between the antenna membrane and the upper board.

4. The keyboard as claimed in claim 1, wherein the antenna membrane is disposed between the upper board and the lower board, and the antenna circuit is located between the antenna membrane and the lower board when the antenna circuit is formed on a lower surface of the antenna membrane, or the antenna circuit is located between the antenna membrane and the upper board when the antenna circuit is formed on an upper surface of the antenna membrane.

5. The keyboard as claimed in claim 1, wherein the membrane circuit board further comprises a middle board disposed between the lower board and the upper board, so as to form the distance between each of the upper contacts and the corresponding one of the lower contacts, and the middle board has a plurality of openings corresponding to the plurality of lower contacts and the plurality of upper contacts.

6. The keyboard as claimed in claim 5, wherein the antenna membrane is disposed between the upper board and the middle board, and the antenna circuit is located between the antenna membrane and the middle board when the antenna circuit is formed on a lower surface of the antenna membrane, or the antenna circuit is located between the antenna membrane and the upper board when the antenna circuit is formed on an upper surface of the antenna membrane.

7. The keyboard as claimed in claim 5, wherein the antenna membrane is disposed between the lower board and the middle board, and the antenna circuit is located between the antenna membrane and the lower board when the antenna circuit is formed on a lower surface of the antenna membrane, or the antenna circuit is located between the antenna membrane and the middle board when the antenna circuit is formed on an upper surface of the antenna membrane.

8. The keyboard as claimed in claim 1, wherein each of the keys has a cap and an elastomer, the elastomer is disposed between the cap and the membrane circuit board, the elastomer is compressed to push the corresponding one of the membrane switches when the cap is pressed, and the elastomer provides an elastic force to the cap for returning the position of the cap when the cap is released.

9. A keyboard, comprising:
a membrane circuit board, comprising:
a switch membrane, having a switch circuit layout on an upper surface thereof, and the switch circuit layout having a plurality of membrane switches; and
an antenna membrane, having an antenna circuit on an upper surface thereof, and the antenna membrane is disposed under the switch membrane, wherein the keyboard transmits or receives a wireless signal by using the antenna membrane; and
a plurality of keys, for corresponding to and switching on the plurality of membrane switches.

10. The keyboard as claimed in claim 9, wherein each of the membrane switches comprises a first conductive portion and a second conductive portion, and the first conductive portion is separated from the second conductive portion.

11. The keyboard as claimed in claim 10, wherein each of the keys has a cap and a conductor, the conductor is disposed between the cap and the membrane circuit board, and the conductor contacts and thus switches on the corresponding one of the membrane switches when the cap is pressed.

12. A keyboard, comprising:
a membrane circuit board, comprising:
a lower board, having a first circuit layout on an upper surface thereof, and the first circuit layout having a plurality of lower contacts;
an upper board, having a second circuit layout on an lower surface thereof, and the second circuit layout having a plurality of upper contacts corresponding to the plurality of lower contacts, wherein each of the plurality of upper contacts is distant from the corresponding one of the plurality of lower contacts with a distance and forms a membrane switch with the corresponding one of the plurality of lower contacts in common; and
an antenna circuit, located between the lower board and the upper board, wherein the keyboard transmits or receives a wireless signal by using the antenna circuit; and
a plurality of keys, for corresponding to and switching on the plurality of membrane switches.

13. The keyboard as claimed in claim 12, wherein the membrane circuit board further comprises a middle board disposed between the lower board and the upper board, so as to form the distance between each of the upper contacts and the corresponding one of the lower contacts, and the middle board has a plurality of openings corresponding to the plurality of lower contacts and the plurality of upper contacts.

14. The keyboard as claimed in claim 13, wherein the antenna circuit is formed on an upper surface or a lower surface of the middle board.

15. The keyboard as claimed in claim 12, wherein each of the keys has a cap and an elastomer, the elastomer is disposed between the cap and the membrane circuit board, the elastomer is compressed to push the corresponding one of the membrane switches when the cap is pressed, and the elastomer provides an elastic force to the cap for returning the position of the cap when the cap is released.
